(19) United States
(12) Patent Application Publication
(10) Pub. No.: US 2005/0202226 A1
(43) Pub. Date: Sep. 15, 2005

(54) Wooden element and method for its manufacture

(76) Inventor: Alfonso Branca, Milano (IT)

Correspondence Address: THE FIRM OF KARL F ROSS, 5676 RIVERDALE AVENUE, PO BOX 900, RIVERDALE (BRONX), NY, 10471-0900, US

(21) Appl. No.: 10/509,901

(22) PCT Filed: Mar. 31, 2003
(86) PCT No.: PCT/EP03/03330

§ 371 Date: Sep. 29, 2004

(30) Foreign Application Priority Data
Apr. 3, 2002 (IT) MI2002 A 000687

(51) Int. Cl. B32B 21/08; B32B 21/10; B05D 3/02; B32B 21/02

(52) U.S. Cl. 428/292.4; 428/528; 428/537.1; 428/541; 427/393; 427/397

(57) ABSTRACT

The wooden element comprises at least one portion of one of its inside and/or outside surface consisting of at least one synthetic resin having a transformation process that changes between the initial step and the final step of realisation of the wooden element.

The present finding relates to a wooden element and to a method for its manufacture.

As known, at present, wood composite products are manufactured according to various processes in which wood in the form of boards, staffs, rotary-cut veneer, chips and fibres, is compressed and bound with synthetic resins and mineral-base adhesives.

In some cases, the binding and adhesive properties of the same materials are activated. Besides using waste and scrap material, such production methods considerably and qualitatively improve the product compared to the raw material.

Imperfections and anomalies, such as knots or cracks, are not found in the composite material, which therefore has a higher resistance.

Composite derivatives are very homogeneous, with minimum variations in the characteristics of the plates.

Such phenomenon greatly benefits them since they are more stable in the computation of the loads and in the static deformation or shrinkage compared to heartwood.

Moreover, advantageously, beam or plate materials can be produced in large sizes, are easy to be machined and advantageous from an ecological standpoint.

By way of an example, it is possible to realise pressed panels or different types of structural plywood using alkaline-phenolic, resorcinolic or phenolic-resorcinolic urea resin, etc, as adhesive for the wooden material.

The use of thermosetting resin-based composite materials is also known for improving the performance of massive wood or of laminated wood, or plywood, of for allowing the use of poor quality wooden elements having the same features as more expensive and higher quality wood.

However, the attempts at actuating such bond with thermosetting resins exhibit some disadvantages due to the difficulty of perfectly adhering to the wood surface.

This could be overcome by the use of aramid fibre surfaces or aramid fibre rough layers on the surface, but this increases the process and the composite costs.

For this reason, dedicated adhesives not commonly used in the wood industry are often required, and this contributes to increasing the costs and restrains acceptance thereof.

Moreover, it should be remembered that wood exhibits a natural tendency to swell and shrink as it absorbs or loses moisture during weather changes.

Thermosetting resin composites exhibit very limited dimensional variations, and they are stiff, with the result that the lack of homogeneity between swellings can cause cracks in the wood or in the composite, or in the binding portion.

Besides implying an additional cost both for the material and for labour, the use of adhesives also implies a loss of the chemical and physical characteristics of the end product, caused by the aging of the adhesives used.

Moreover, the product manufacturing processes are very long due to the use of adhesives.

Last but not least, the use of adhesives also implies the formation of air bubbles between laminated wood and composite wooden product, which tend to exhibit physical behaviours that are detrimental to the product, or the execution of rolling operations to eliminate them, or even pressing treatment operations.

The task of the present finding is that of eliminating the disadvantages of the prior art described above.

Within this task, an object is that of realising a wooden element and a method for its manufacture, which should allow eliminating the use of adhesives for binding the wood with a synthetic resin or with a composite material.

Another object of the finding is that of realising a wooden element and a method for its manufacture which should allow exhibiting a considerable resistance to fire, making the product usable in all of the industry fields requiring materials with fire retardant properties.

Another object is that of realising a wooden element and a method for its manufacture which should allow reducing the manufacturing costs and labour maintaining the mechanical properties of the end product unaltered.

Last but not least, another object is that of realising a wooden element and a method for its manufacture which should allow having very limited manufacturing times, preventing the formation of air bubbles during the binding of the resin or of the composite material with the wood.

This task, as well as these and other objects, are achieved by a wooden element characterised in that it comprises at least one portion of one of its inside and/or outside surfaces, consisting of at least one synthetic resin having a transformation process that changes between the initial step and the final step of realisation of said wooden element.

Another object of the present patent for invention is a method for realising a wooden element characterised in that it consists in associating, inside or outside the wooden element, at least one thermoplastic phenolic resin-based composite material, melting said resin at a predetermined temperature for obtaining a perfect penetration of said resin into the protuberances -of said wooden element, and transforming said thermoplastic phenolic resin into a thermosetting resin.

Moreover, according to the finding, also the use of a thermoplastic phenolic resin to associate to a wooden element with final effect of thermosetting resin consisting of laminated wood with unidirectional vein (LVL) or a laminated wood with vein at 90° between each layer (Plywood), or of wooden pieces glued under. pressure (Glulam) or parallel wooden slabs (PSL) or-having a specific orientation (OSB), or similar ones, is new and inventive.

Further features and advantages of the invention will appear more clearly from the description of a preferred but not exclusive embodiment of the wooden element according to the finding.

The wooden element comprises at least one portion, which can indifferently be of one of its inside and/or outside surfaces, consisting of at least one synthetic resin having a transformation process that changes between the initial step and the final step of realisation of said wooden element.

More precisely, this portion of the wooden element consists of a composite material based on a synthetic resin which in the initial step is a thermoplastic phenolic resin and in the final step is a thermosetting phenolic resin.

The phenolic resin used is in the form of a film.

In a preferred solution, a composite material is used that, according to the requirements, is in the form of a composite or pre-composite plate-shaped element or is in the form of a staff-shaped element for fixing and/or reinforcing the wooden element, such as for example a wooden beam.

In the case of the film, this comprises a sheet containing mono-directional fibres or fibres oriented according to different axes, and it is a derivative of a felt fabric, and/or a sewn felt and/or a felt with cut thread, and/or a spunbonded fabric.

In most cases, the wooden element will not be massive wood but a composite wooden product comprising a phenolic-based adhesive, and in particular, a stratified laminated wood.

In a preferred embodiment, the realisation of the wooden element described above consists in associating, inside or outside it, at least one thermoplastic phenolic resin-based composite material.

The resin is then melted at a predetermined temperature for obtaining a perfect penetration of the resin into the protuberances and into the pores of the wooden element, so as to have a perfect deep penetration between the two elements.

The thermoplastic phenolic resin is then transformed into a thermosetting phenolic resin, with all the advantages given by this operation, both from the physical and from the mechanical point of view.

If deemed suitable, in the case of a wood coating obtained by a thermoplastic phenolic resin it is possible to apply a thermosetting composite.

Advantageously, the phenolic resin-based composite material used is obtained by pultrusion.

During the pultrusion process it is necessary to avoid the final hardening step of the phenolic resin, so that the latter remains partly or totally thermoplastic, to proceed then to its partial or total melting.

In the wood association process, the thermoplastic resin is melted to obtain an intimate connection without using adhesives, then transforming the thermoplastic phenolic resin into a thermosetting phenolic resin.

Before or during its application on the wood, the composite material is thermo-formed and shaped.

In the case of thermo-forming, this is realised at a sufficiently high temperature to soften the thermoplastic resin, but sufficiently low to prevent the onset of the crosslinking reaction.

As seen, the wooden element can be of any of the types currently available on the market.

For example, a laminated wood with unidirectional vein (LVL) or a laminated wood with vein at 90° between each layer (Plywood), or wood pieces glued under pressure (Glulam), or parallel wooden slabs (PSL), or having a specific orientation, for example OSB (acronym defining Oriented Strand Board) Practical Board, medium density fibre board (MDF) and fibreboard.

Preferably, the composite material is in the form of a plate-shaped element.

The physical shape of the composite may even be, for example, a staff that may be used for fixing or reinforcing beams or existing structures, or for reinforcing them locally. Both staffs and sheets can be thermo-formed and shaped to be mounted on the wooden structure in the production line or after production, or even at the installation site.

Forming can be carried out either when they are fixed on site or beforehand, using sufficiently high temperatures to soften the thermoplastic resin, but sufficiently low to prevent the onset of the crosslinking reaction.

Another big advantage obtained by the present finding is that of flammability, thanks to the intrinsic fire resistance of phenolic resins.

The foregoing is a considerable advantage in a large series of applications wherein the phenolic layer would not only be a reinforcement layer, but it would also act as fire barrier.

Two embodiments are reported hereinafter by way of an example.

### EXAMPLE 1

Phenolic Composite in Plywood

The plywood is produced by gluing together thin wooden sheets in an adhesive manner so that the wooden fibres between consecutive layers alternate in one direction for obtaining panels with a good resistance in both directions. The sheets are typically 4′ large and 8′ long, with a thickness of about 0.1″.

The layers are stacked into a heated press with the fibres alternating in the direction. The sheets may be stacked in a press manually heated by an operator, or they may be fed by an automated machine. The adhesive is applied to the sheets before they are arranged into the press, using a cascaded spreading machine on a line that feeds the sheets to the assembly station, or they may be brought by hand to the assembly station. The adhesive typically is a phenolic formaldehyde (PF) or a resorcinol phenolic formaldehyde (PRF). Once a sufficient number of layers has been stacked to create the required thickness, the press is closed and the plywood is hardened by the heat coming from the press platens or by radiofrequency heating (RF). Once the adhesive has hardened, the platens are opened and the plywood panel is removed. In most cases, it is possible to realise multiple plywood sheets at once, stacked on each other into the same press.

Sometimes it is desirable to obtain better properties. in one or both directions with respect to what can be obtained using wood only. In this case it may be advantageous to include thin composite sheets into the plywood. The problem with most composites is that the adhesives required for making them adhere to wood in an appropriate manner are different from those used to realise the plywood. This is difficult for the efficient manufacture of plywood.

The present invention allows adding the composite into the wood. in complete or partial sheets without using another adhesive. It is possible to simply add the composite sheets into the plywood between the wooden sheets. Since the composite matrix is a non-hardened phenolic resin, the press heat will melt the matrix and make it partly flow into the wooden sheet fibres, making it harden/reticulate, giving a strong adhesion between the wood and the composite as a result.

The final properties of the plywood panel can be varied in a wide range according to the number of composite layers used and to their thickness.

### EXAMPLE 2

Phenolic composite in glued laminar wooden beams. Glued laminar wooden beams are produced by gluing wooden wooden strip layers together to form a larger wooden beam. The strips typically have a thickness of 1½″ and a width comprised between 3″ and 12″. A small beam, such as for example that used for hanging a garage door, may be just 7″ 10″ deep and consist of 5-8 wooden strips. Larger beams, such as for example those used for roof or bridge systems, may be up to 60″ deep and consist of 40 layers of wooden strips. Wooden strips are typically made to pass through a cascaded spreading machine to apply PF or PRF adhesive, and then they are stacked manually or by a machine to form the beam. The beam is mounted into a manual or automated press and the adhesive is hardened using the heat coming from either the press or from an RF heating device.

In order to obtain the highest structural resistance, wooden strips are carefully selected and arranged in such a way as to have the wood with the best properties closer to outside surface (i.e., to the top or bottom of the beam) since this is the zone with the highest stresses.

Sometimes it is desirable to obtain better properties and higher uniformity of such properties than what can be obtained by using wood alone. In this case it may be advantageous to add external composite layers (i.e., to the top and bottom surfaces), or a layer taken from the exterior. The composite strips should have a thickness comprised between 1/16″, up to 1″, according to the additional properties required of the beam. This base wood is well known in the industry but it is seldom kept into consideration due to the costs of the composite, to the complexity of the gluing between composite and wood (since special adhesives and a composite surface preparation are required) and to the problems related to the composite flammability and heat.

The present invention addresses the problems mentioned above and can be applied to the wooden beam.

It is possible to add composite strips with a non-hardened thermoplastic phenolic resin matrix without adhesive to the glued laminar wooden beam at the outside layer or in the proximity of the latter (for example, a layer taken from the outside surface during the beam assembly). When the entire beam has hardened, the thermoplastic phenolic matrix flows into the wooden fibres and then it crosslinks and hardens, thereby creating an excellent adhesion with the wood.

In all of the cases mentioned above, the thermoplastic phenolic resin may be extruded on a different composite and be used only as adhesive layer, with the advantage that it would not be necessary to use a separate liquid glue.

The above description refers to examples of two possible types of “structured wood” to which it is advantageously possible to combine the thermoplastic composite. It must be understood that the thermoplastic phenolic composite could advantageously be combined with many other wooden products using similar base woods, including: Laminated Veneer Lumber (LVL, wooden-based product consisting of basically chamfering-jointed sheets and superimposed with parallel fibres and slightly overlapped headpieces (transversal edges), Parallel Strand Lumber (PSL, wooden product consisting of glued particles), structured I-shaped joists, wood agglomerates, oriented strand board panels (OSB).

In the practice, it has been proved that the wooden element according to the finding is advantageous in that it exhibits a considerable resistance to fire, which makes the product usable in all of the industry sectors that require fire-retardant properties of the materials, and moreover in that it allows eliminating the use of adhesives in the processes for binding a resin laminate with the wooden composite product.

The finding thus conceived can be subject to several modifications and variants, all falling within the scope of the inventive concept.

Moreover, all parts can be replaced with technically equivalent elements.

1. A wooden element comprising least one portion of one of its inside and/or outside surface consisting of at least one synthetic resin having a transformation process that changes between the initial step and the final step of formation of said wooden element.

2. The wooden element according to claim 1 wherein said portion consists of a synthetic resin-based composite material exhibiting a transformation process that changes between the initial step and the final step of realisation of said wooden element.

3. The wooden element according to claim 1 wherein said synthetic resin in said initial step is a thermoplastic phenolic resin and in said final step is a thermosetting phenolic resin.

4. The wooden element according to claim 3 wherein said phenolic resin is in the form of a film.

5. The wooden element according to claim 2 wherein said composite material is in the form of a composite or pre-composite plate-shaped element.

6. The wooden element according to claim 2 wherein said composite material is in the form of a staff-shaped element for its fixing and/or stiffening.

7. The wooden element according to claim 4 wherein said film comprises a sheet containing unidirectional fibers.

8. The wooden element according to that claim 7 wherein said film comprises fibres oriented according to different axes and is a derivative of a felt fabric, and/or a sewn felt and/or a felt with cut thread, and/or a spunbonded fabric.

9. The wooden element according to claim 1 which is a composite wooden product comprising a phenolic-based adhesive.

10. The wooden element according to claim 1 which is a stratified laminated wood.

11. A method for the manufacture of a wooden element, which comprises associating, inside or outside the wooden element, at least one thermoplastic phenolic resin-based composite material, melting said resin at a predetermined temperature for obtaining a perfect penetration of said resin into the protuberances of said wooden element, and transforming said thermoplastic phenolic resin into a thermosetting phenolic resin.

12. The method according to claim 11 wherein a thermosetting composite is applied onto said thermoplastic phenolic resin coating.

13. The method according to claim 12 wherein said phenolic resin-based composite material is obtained by pultrusion, avoiding the final hardening step of the phenolic resin, so that the latter remains partly or totally thermoplastic, then melting said partly or totally thermoplastic resin in the association process to said wood, for a intimate connection without using adhesives, then transforming said thermoplastic phenolic resin into a thermosetting phenolic resin.

14. The method according to claim 13 wherein before or during its application on said wooden element, said composite material is thermo-formed and shaped.

15. The method according to claim 14 wherein the thermo-forming process occurs at a sufficiently high temperature to soften the thermoplastic resin, but sufficiently low to prevent the onset of the crosslinking reaction.

16. The method according to claim 15 said composite material is in the form of a plate-shaped element.

17. The method according to claim 15 wherein said composite coating is in the form of a staff.

18. The use of a thermoplastic phenolic resin to associate to a wooden element with final effect of thermosetting resin, consisting of a laminated wood with unidirectional vein (LVL), or a laminated wood with vein at 90° between each layer (Plywood), or wood pieces glued under pressure (Glulam), or parallel wooden slabs (PSL), or having a specific orientation (OSB), and similar ones.
